(19) United States
(12) Patent Application Publication
(10) Pub. No.: US 2013/0330956 A1
(43) Pub. Date: Dec. 12, 2013

(54) Joint Connector

(71) Applicant: Yazaki Corporation, Tokyo (JP)

(72) Inventor: Tomohiko Shimizu, Makinohara-shi (JP)

(73) Assignee: YAZAKI CORPORATION, Tokyo (JP)

(21) Appl. No.: 13/967,480

(22) Filed: Aug. 15, 2013

Related U.S. Application Data
(63) Continuation of application No. PCT/JP2012/053247, filed on Feb. 13, 2012.

(30) Foreign Application Priority Data
Feb. 15, 2011 (JP) 2011-030100

(51) Int. Cl. H01R 13/627

(52) U.S. Cl. CPC H01R 13/627
USPC 439/345

(57) ABSTRACT

A joint connector includes a plurality of female terminal fittings, a joint terminal that includes a plurality of tab pieces to which the female terminal fittings are fitted and connected and a connecting portion which conductively connects the tab pieces to each other, and a resin connector housing that includes one end which accommodates and holds the joint terminal in a state where the tab pieces face the other end of the housing, the other end in which female terminal accommodating holes are arranged to cause the female terminal fittings and the tab pieces to be engaged with each other by inserting the female terminal fittings to a specified position, and lances that include elastic pieces extending along the female terminal accommodating holes and protrusions which are protruded on a free end side of the elastic pieces toward the female terminal accommodating holes.

### CROSS REFERENCE TO RELATED APPLICATION

This application is a continuation of PCT application No. PCT/JP2012/053247, which was filed on Feb. 13, 2012 based on Japanese Patent Applications No. 2011-030100 filed Feb. 15, 2011, the contents of which are incorporated herein by reference.

### BACKGROUND OF THE INVENTION

1. Technical Field

The present invention relates to a joint connector which is used to connect a plurality of wires to each other or to distribute one line wire into a plurality of wires.

2. Background Art

FIG. 5 shows an example of a conventional joint connector.

The joint connector 100 is disclosed in the following PTL1 and includes a joint terminal (bus bar) 110, a plurality of female terminal fittings 120, a first connector housing 130 and a second connector housing 140.

The joint terminal 110 is a press-molded product of metal plate and includes a plurality of tab pieces 111 to which the female terminal fittings 120 are fitted and connected and a connecting portion 112 which conductively connects these tab pieces 111 to each other.

The female terminal fitting 120 is a press-molded product of metal plate and includes a square tubular box portion 121 to which the tab piece 111 is fitted, a wire caulking portion 122 which extends from a rear end of the box portion 121 to crimp a wire 150 and an engaging recess 123 for missing-prevention.

The first connector housing 130 is an injection-molded product of resin and includes housing's one end 131 and a cylindrical hood portion 132 extending from the housing's one end 131.

The housing's one end 131 accommodates and holds the joint terminal 110 in a state where the tab pieces 111 face the other end 130a (a right end in FIG. 5) side of the housing. The housing's one end 131 retains the joint terminal 110 by insert molding, for example.

The hood portion 132 is a cylindrical portion to which the second connector housing 140 is fitted. The hood portion 132 is provided with a lock hole portion 134 for fixing the second connector housing 140 fitted thereto.

The second connector housing 140 accommodates and holds the female terminal fittings 120 and is fitted and connected to the first connector housing 130.

The second connector housing 140 includes a plurality of female terminal accommodating holes 141 to accommodate the female terminal fittings 120, lances 142 to prevent the missing of the female terminal fittings 120 inserted into the female terminal accommodating holes 141 and lock protrusions 143 to lock an engaging state with the first connector housing 130.

The lance 142 includes an elastic piece 142a extending along the female terminal accommodating hole 141 and a terminal locking protrusion 142b which is protruded on a free end side of the elastic piece 142a toward the female terminal accommodating hole 141. In the lance 142, the elastic piece 142a is subjected to flexural deformation to allow the insertion of the female terminal fitting 120 so that the terminal locking protrusion 142b is retracted to the outside of the female terminal accommodating hole 141 by interference between the box portion 121 of the female terminal fitting 120 and the terminal locking protrusion 142b while the female terminal fitting 120 is inserted into the female terminal accommodating hole 141. When the female terminal fitting 120 is inserted to a specified position, the terminal locking protrusion 142b is engaged with the engaging recess 123 of the female terminal fitting 120 by an elastic restoring force of the terminal locking protrusion 142b, thereby preventing missing of the female terminal fitting 120.

When fitting between the first connector housing 130 and the second connector housing 140 has been properly completed, the lock protrusion 143 is engaged with the lock hole portion 134 of the first connector housing 130 to lock an engaging state between these connector housings.

In the joint connector 100 described above, haft-fitting detection protrusions 135 as a means to detect a half-fitted state are provided in the housing's one end 131 of the first connector housing 130 when the female terminal fittings 120 mounted to the second connector housing 140 are in the half-fitted (incomplete insertion) state where the female terminal fittings 120 do not reach the specified position.

When the first connector housing 130 and the second connector housing 140 are fitted to each other, the haft-fitting detection protrusion 135 is a protrusion which is inserted into a retraction space 145 for the lance 142. When the female terminal fitting 120 is in a half-fitted state where the female terminal fitting 120 is not completely fitted into the female terminal accommodating hole 141, the lance 142 is deflected and displaced toward the retraction space 145. Accordingly, when these housings are fitted to each other, the haft-fitting detection protrusion 135 is interfered with a leading end of the lance 142 being displaced to the retraction space 145 and therefore fitting between the housings is prevented. In this way, it is detected that the female terminal fitting 120 is in the half-fitted state.

### CITATION LIST

### Patent Literature

PTL1: JP-A-H8-250185

### SUMMARY OF THE INVENTION

In the joint connector 100 described above, since it is necessary to separately prepare the first connector housing 130 and the second connector housing 140, there is a problem that the number of parts is increased and therefore increase in cost is caused. Accordingly, in order to suppress increase in cost, the present inventors has considered a joint connector in which both a joint terminal and a female terminal fitting are accommodated in a single housing and existing one is diverted as a female terminal fitting. The existing female terminal fitting to be diverted in this case includes a primary locking protrusion (front protrusion) at a front side and a protrusion (rear protrusion) as a stabilizer at a rear side. However, in a case where the existing female terminal fitting is used, it has been newly found that the following problems arise.

That is, when fixing the female terminal fitting inserted to the housing, it is general that the female terminal fitting is locked by a flexible lance provided in a female accommodating hole. In this case, when the female terminal fitting having two protrusions on a front side and a rear side is fixed by the lance, the lance is engaged with the front protrusion in a stage before the rear protrusion to be originally engaged with the lance passes the lance and after the front protrusion passes the lance. For this reason, it has been newly found that there is a risk of misunderstanding that the insertion of the female terminal fitting has been completed, in spite of mid-insertion state.

Accordingly, an object of the present invention is to solve the above-described problems and to provide a joint connector which is capable of preventing an erroneous locking in an incomplete insertion state of the female terminal fitting.

The object of the present invention is achieved by the following configurations.

(1) A joint connector includes:
a plurality of female terminal fittings;
a joint terminal that includes a plurality of tab pieces to which the female terminal fittings are fitted and connected and a connecting portion which conductively connects the tab pieces to each other and;
a resin connector housing that includes:
   one end which accommodates and holds the joint terminal in a state where the tab pieces face the other end of the housing;
   the other end in which female terminal accommodating holes are arranged to cause the female terminal fittings and the tab pieces to be engaged with each other by inserting the female terminal fittings to a specified position; and
   lances that include elastic pieces extending along the female terminal accommodating holes and protrusions which are protruded on a free end side of the elastic pieces toward the female terminal accommodating holes to retain the female terminal fittings inserted to the specified position.

A front protrusion and a rear protrusion are provided on a side of the female terminal fitting along an insertion direction of the female terminal fitting into the female terminal accommodating hole, the front protrusion and the rear protrusion protruding in the same direction intersecting the insertion direction of the female terminal fitting. The front protrusion and the rear protrusion is spaced apart from each other in the insertion direction of the female terminal fitting. The front protrusion and the rear protrusion is provided independently of one another and having positions offset in a lateral direction crossing the insertion direction. The lance is provided with a locking wall which is engaged with the rear protrusion to retain the female terminal fitting when the rear protrusion passes the lance and a rib which prevents the locking wall from being engaged with the front protrusion when the front protrusion passes the lance.

(2) In the joint connector of (1), an end along the terminal insertion direction of the rib provided in the lance is fixed to the connector housing and the lance has a structure supported at both ends.

According to the joint connector having a configuration of the above (1), since the rib prevents the front protrusion from being engaged with the locking wall when the front protrusion passes the lance, the locking wall of the lance can be engaged with the rear protrusion only when the female terminal fitting is inserted to a specified position and the rear protrusion passes the lance. Accordingly, it is possible to prevent an erroneous locking of the female terminal fitting in an incomplete insertion state and therefore it is possible to eliminate a risk of misunderstanding that the insertion of the fitting has been completed, in spite of the incomplete insertion state.

According to the joint connector having a configuration of the above (2), since the lance has a structure supported at both ends, a terminal holding force is increased.

According to the present invention, it is possible to prevent an erroneous locking in an incomplete insertion state of the female terminal fitting and therefore it is possible to eliminate a risk of misunderstanding that the insertion of the female terminal fitting has been completed, in spite of the incomplete insertion state.

### BRIEF DESCRIPTION OF DRAWINGS

FIG. 1 is an exploded perspective view showing an illustrative embodiment of a joint connector device according to the present invention.

FIG. 2 is a perspective view of a leading end side of a female terminal fitting shown in FIG. 1, as seen from the obliquely-upper side.

FIG. 3 is a partially cut-away perspective view showing an internal structure of a housing of the joint connector shown in FIG. 1.

FIG. 4A and FIG. 4B are views for explaining an operation when a female terminal fitting is inserted into a housing of the joint connector shown in FIG. 1. FIG. 4A is a side sectional view showing a state where the female terminal fitting is inserted halfway and FIG. 4B is a longitudinal sectional view showing a state where the female terminal fitting is completely inserted.

FIG. 5 is a longitudinal sectional view showing an exploded state of a conventional joint connector.

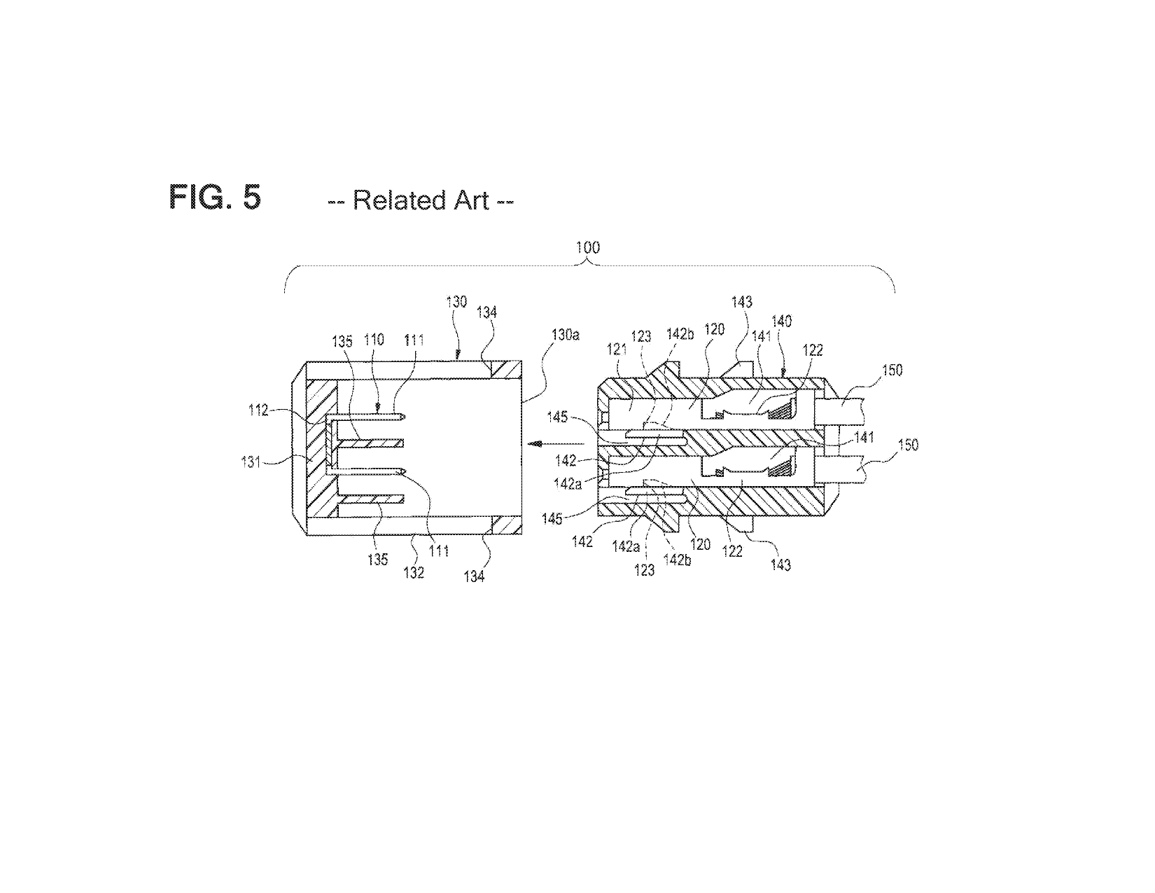

### DESCRIPTION OF EMBODIMENTS

Hereinafter, an illustrative embodiment of the present invention will be described with reference to the drawings.

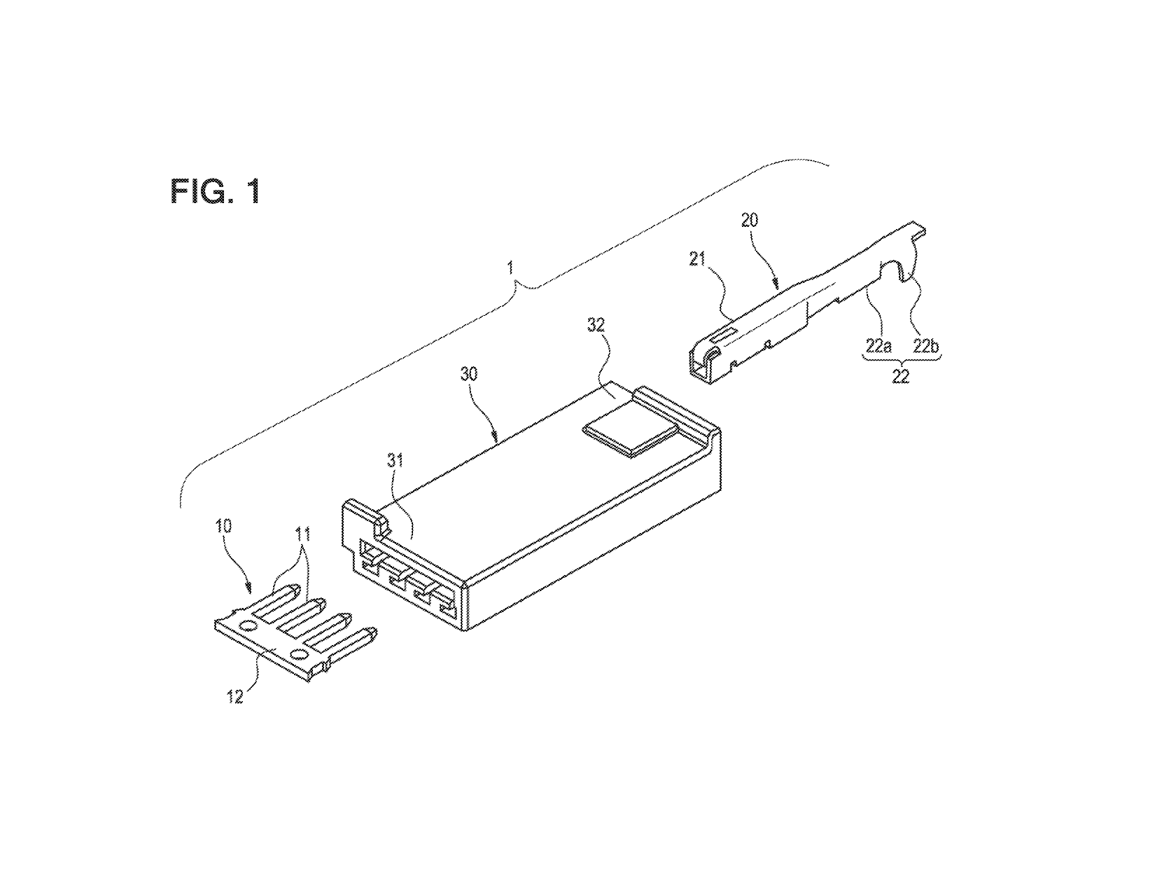

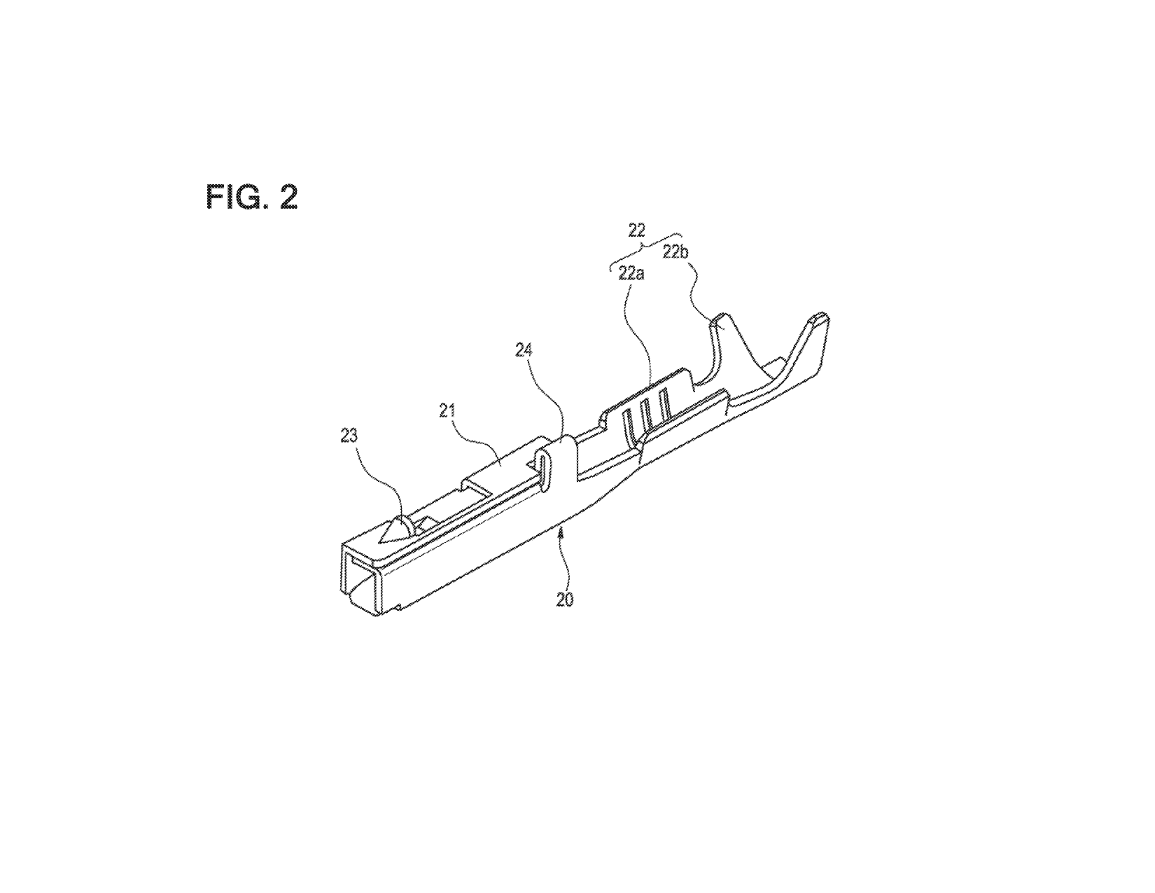

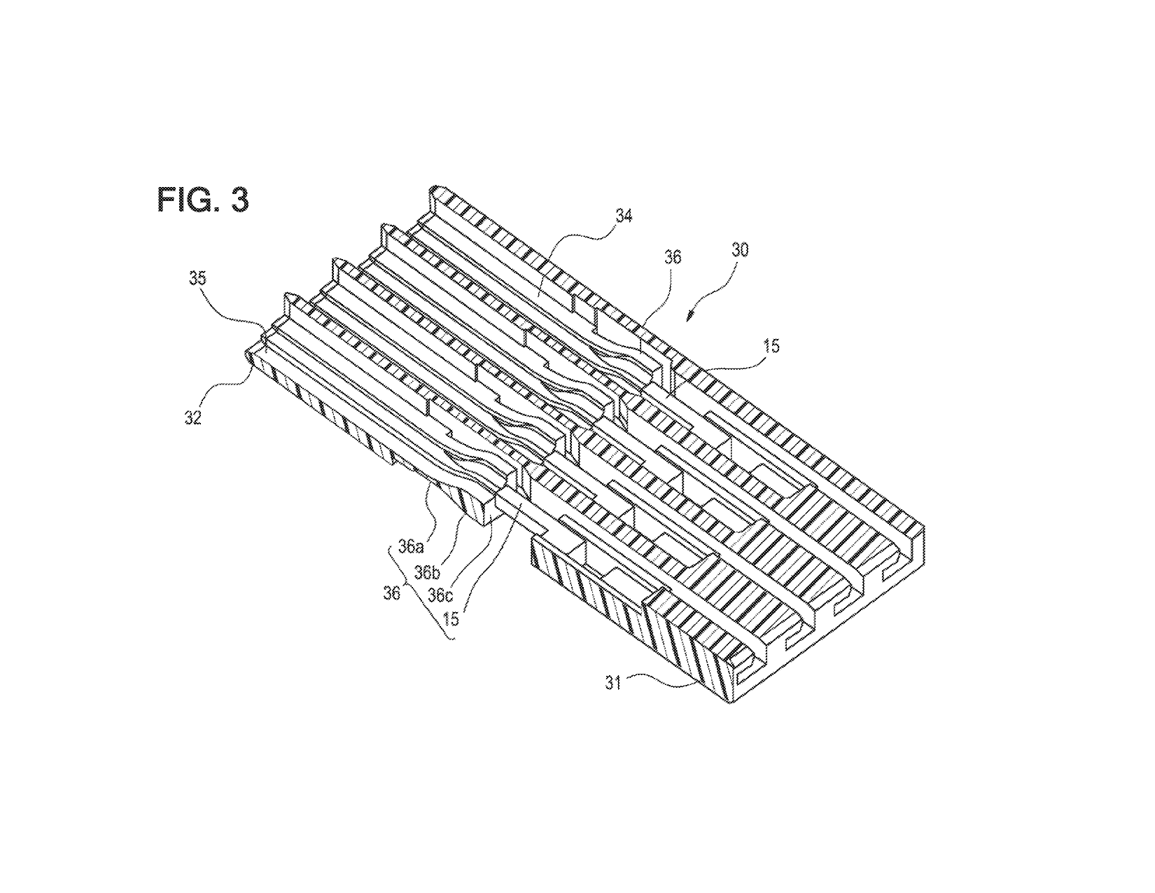

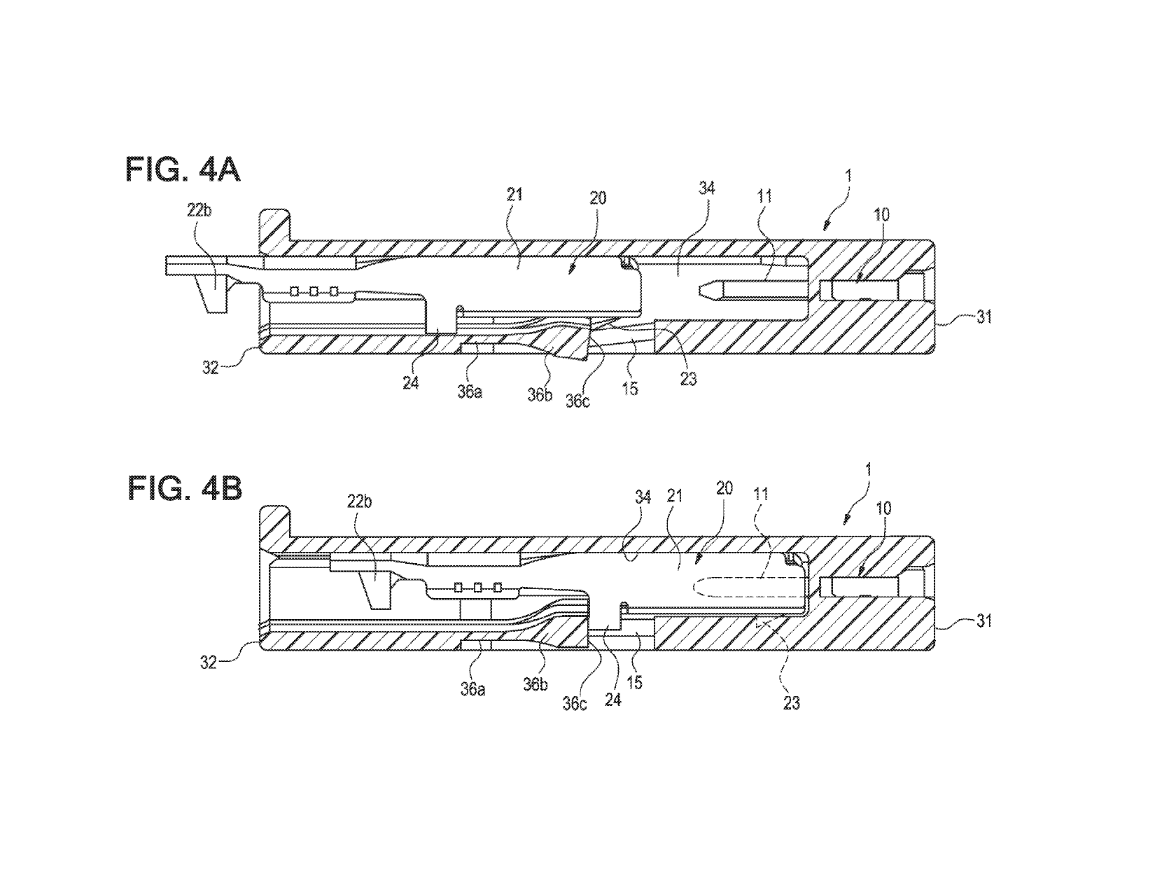

FIG. 1 is an exploded perspective view showing an illustrative embodiment of a joint connector according to the present invention. FIG. 2 is a perspective view of a leading end side of a female terminal fitting shown in FIG. 1, as seen from the obliquely-upper side. FIG. 3 is a partially cut-away perspective view showing an internal structure of a housing of the joint connector shown in FIG. 1. FIG. 4A and FIG. 4B are views for explaining an operation when a female terminal fitting is inserted into a housing of the joint connector shown in FIG. 1. FIG. 4A is a side sectional view showing a state where the female terminal fitting is inserted halfway and FIG. 4B is a longitudinal sectional view showing a state where the female terminal fitting is completely inserted.

As shown in FIG. 1, a joint connector 1 of the present embodiment includes a joint terminal 10, a female terminal fitting 20, a resin connector housing 30.

The joint terminal 1 is a press-molded product of metal plate and includes a plurality of tab pieces 11 to which the female terminal fittings 20 are fitted and connected and a connecting portion 12 which conductively connects these tab pieces 11 to each other.

As shown in FIG. 1 and FIG. 2, the female terminal fitting 20 is a press-molded product of metal plate and includes a square tubular box portion 21 to which the tab piece 11 is fitted, a wire caulking portion 22 which extends from a rear end of the box portion 21 to crimp a wire and a protruding piece 24 (rear protrusion described below) for insertion guide.

The electric caulking portion 22 includes a conductor caulking piece 22a to crimp a conductor of the wire and a covering caulking piece 22b to fix the wire by being caulked to a covering portion of the wire.

Since the female terminal fitting 20 is a diversion product of another connector terminal, the female terminal fitting is provided with a primary locking protrusion (hereinafter, referred to as a “front protrusion”) 23 and an insertion guiding protrusion piece (hereinafter, referred to as a “rear protrusion”) 24, which are provided on a side of the female terminal fitting along an insertion direction of the female terminal fitting 20 into the female terminal accommodating hole 34. The front protrusion and the rear protrusion protrude in the same direction intersecting the insertion direction of the female terminal fitting 20. Further, the front protrusion and the rear protrusion are spaced apart from each other before and after in the insertion direction of the female terminal fitting 20, are provided independently of one another and have positions offset in a lateral direction crossing the insertion direction.

The rear protrusion 24 is a tongue-shaped piece which extends along the insertion direction of the connector housing 30 (which will be described below) into the female terminal accommodating hole 34 in the position of the rear end side of the box portion 21. The rear protrusion 24 is formed into a tongue shape by extending and bend-molding a part of a side wall of the box portion 21.

The connector housing 30 is an injection-molded product of resin and includes housing's one end 31 and housing's the other end 32 which is an end opposite to the housing's one end 31.

As shown in FIG. 4A and FIG. 4B, the housing's one end 31 accommodates and holds the joint terminal 10 in a state where the tab piece 11 faces the housing's the other end 32 side.

As shown in FIG. 3, FIG. 4A and FIG. 4B, a plurality of female terminal accommodating holes 34 are arranged in the housing's the other end 32. The plurality of female terminal accommodating holes 34 are holes to cause the female terminal fittings 20 and the tab pieces 11 to be engaged with each other by inserting the female terminal fittings 20 to a specified position. Herein, the specified position refers to a position there the tab piece 11 and the box portion 21 can obtain a sufficient contact length required for electric connection.

As shown in FIG. 3, the female terminal accommodating hole 34 is provided with a guide groove 35. The guide groove 35 slidably guides the rear protrusion 24 to guide the female terminal fitting 20 to the specified position when inserting the female terminal fitting 20 into the female terminal accommodating hole 34.

As shown in FIG. 3, FIG. 4A and FIG. 4B, the lance 36 includes an elastic piece 36a extending along the female terminal accommodating hole 34 and a terminal locking protrusion 36b protruding on the elastic piece 36a (right end in FIG. 4A and FIG. 4B).

The terminal locking protrusion 36b protrudes toward the female terminal accommodating hole 34 and is engaged with the rear protrusion 24 inserted to the specified position to retain the female terminal fitting 20, as shown in FIG. 4B.

The terminal locking protrusion 36b is provided at its front end with an locking wall 36c which is engaged with the rear protrusion 24 to retain the female terminal fitting 20 when the female terminal fitting 20 is inserted into the female terminal accommodating hole 34 of the connector housing 30 and the rear protrusion 24 passes the lance 36. Further, a rib 15 is protruded on the locking wall 36c and prevents the locking wall 36c from being engaged with the front protrusion 23 when the front protrusion 23 passes the lance 36. In this case, the rib 15 is provided at a left and right position where the rib is interfered with the front protrusion 23 but not interfered with the rear protrusion 24.

One end of the rib 15 is fixed to the lance 36. Although the other end of the rib 36 may be a free end without being fixed anywhere, the other end is fixed to the connector housing 30 in the present embodiment. As a result, the lance 36 has a structure supported at both ends and therefore a terminal holding force by the lance 36 is increased.

When assembling the joint connector 1, first, the joint terminal 10 is mounted to a front portion (housing's one end 31) of the connector housing 30. Next, the female terminal fittings 20 are inserted into each female terminal accommodating hole 34 from the rear of the connector housing 30. At this time, as shown in FIG. 4A, when the front protrusion 23 passes the lance 36, the rib 15 is interfered with the front protrusion and thus the lance 36 is deflected outward, so that it is possible to prevent the front protrusion 23 from being engaged with the locking wall 26c and the front protrusion 23 can pass the lance 36 as it is. Further, in a stage where the female terminal fitting 20 is further inserted to the specified position and the rear protrusion 24 passes the lance 36, the rib 15 is placed at a position where the rib is not interfered with the rear protrusion 24. Therefore, the rear protrusion 24 can be engaged with the locking wall 36c of the lance 36 which returns from a deflected state due to the passage of the rear protrusion 24. For the first time in this stage, it is possible to fix the female terminal fitting 20 while preventing missing of the female terminal fitting 20.

Accordingly, it is possible to prevent an erroneous locking of the female terminal fitting 20 in an incomplete insertion state and therefore it is possible to eliminate a risk of misunderstanding that the insertion of the female terminal fitting 20 has been completed, in spite of the incomplete insertion state. As a result, it is possible to prevent joint failure in advance.

In addition, the present invention is not limited to the above-described illustrative embodiments and various modifications and improvements may be made to the illustrative embodiments. Furthermore, materials, shapes, dimensions, numerical values and locations or the like of each component in the above-described illustrative embodiments are not limited but may be arbitrarily set, as long as the object of the present invention can be achieved.

Although the present invention has been described in detail with reference to the particular embodiments, it is obvious to those skilled in the art that the particular embodiments can be variously modified and changed without departing a spirit and a scope of the present invention.

### INDUSTRIAL APPLICABILITY

According to the present invention, it is possible to prevent an erroneous locking in an incomplete insertion state of the female terminal fitting and therefore it is possible to eliminate a risk of misunderstanding that the insertion of the female terminal fitting has been completed, in spite of the incomplete insertion state.

### REFERENCE NUMERALS LIST

1: JOINT CONNECTOR

10: JOINT TERMINAL

11: TAB PIECE

15: RIB

20: FEMALE, TERMINAL FITTING

21: BOX PORTION

23: FRONT PROTRUSION

24: REAR PROTRUSION (PROTRUDING PIECE FOR INSERTION GUIDE)

30: CONNECTOR HOUSING

31: HOUSING'S ONE END

32: HOUSING'S THE OTHER END

34: FEMALE TERMINAL ACCOMMODATING HOLE

35: GUIDE GROOVE

36: LANCE

36b: TERMINAL LOCKING PROTRUSION

36c: LOCKING WALL

What is claimed is:

1. A joint connector comprising:
a plurality of female terminal fittings,
a joint terminal that includes a plurality of tab pieces to which the female terminal fittings are fitted and connected and a connecting portion which conductively connects the tab pieces to each other and,
a resin connector housing that includes:
one end which accommodates and holds the joint terminal in a state where the tab pieces face the other end of the housing;
the other end in which female terminal accommodating holes are arranged to cause the female terminal fittings and the tab pieces to be engaged with each other by inserting the female terminal fittings to a specified position; and
lances that include elastic pieces extending along the female terminal accommodating holes and protrusions which are protruded on a free end side of the elastic pieces toward the female terminal accommodating holes to retain the female terminal fittings inserted to the specified position,
wherein a front protrusion and a rear protrusion are provided on a side of the female terminal fitting along an insertion direction of the female terminal fitting into the female terminal accommodating hole, the front protrusion and the rear protrusion protruding in the same direction intersecting the insertion direction of the female terminal fitting, the front protrusion and the rear protrusion being spaced apart from each other in the insertion direction of the female terminal fitting, and the front protrusion and the rear protrusion being provided independently of one another and having positions offset in a lateral direction crossing the insertion direction, and
the lance is provided with a locking wall which is engaged with the rear protrusion to retain the female terminal fitting when the rear protrusion passes the lance and a rib which prevents the locking wall from being engaged with the front protrusion when the front protrusion passes the lance.

2. The joint connector according to claim 1, wherein an end along the terminal insertion direction of the rib provided in the lance is fixed to the connector housing and the lance has a structure supported at both ends.
